(19) United States
(12) Patent Application Publication
(10) Pub. No.: US 2008/0083882 A1
(43) Pub. Date: Apr. 10, 2008

(54) Laser desorption assisted field ionization device and method

(76) Inventor: Jian Bai, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/539,280

(22) Filed: Oct. 6, 2006

(51) Int. Cl. H01J 27/24

(52) U.S. Cl. 250/423 P

(57) ABSTRACT

The invention provides a mass spectrometry system, including an ion source for ionizing a sample. The ion source includes a surface for holding and ionizing the sample, an ion collection device adjacent to the surface for receiving ions that are ionized from the surface, a voltage source in electrical connection with the surface and the ion collection device for defining a field ionization field between the surface and the ion collection device, and a light source adjacent to the surface for producing a light source for irradiating and ionizing the sample on the surface, wherein the voltage source produces a field ionization field for ionizing the sample and the light source produces a light for irradiating and ionizing the sample and the same sample on the surface is ionized; and a detector downstream from the ion source for detecting the ions.

The invention also provides an ion source for ionizing a sample. The ion source includes a surface for holding and ionizing a sample, an ion collection device adjacent to the surface for receiving ions that are ionized from the surface, a voltage source in electrical connection with the surface and the ion collection device for defining a field ionization field between the surface and the collection device, and a light source adjacent to the surface for producing a light for irradiating and ionizing the sample on the surface, wherein the voltage source produces a field ionization field for ionizing the sample and the laser produces a light source for irradiating and ionizing the sample and the sample on the surface is ionized.

The invention also provides a method for ionizing a sample. The method includes the steps of applying a field ionization field to the sample and irradiating the sample with a light source to ionize the sample.

### BACKGROUND

According to the matrix assisted laser desorption ionization (MALDI) method of ionization, the analyte and matrix are applied to a sample plate or substrate. As the solvent evaporates the analyte and matrix co-precipitate out of solution to form a solid solution of the analyte in the matrix onto the plate/substrate. The co-precipitate is then irradiated with a short laser pulse inducing the accumulation of a large amount of energy in the co-precipitate through the electronic excitation or molecular vibration of the matrix molecules. The matrix dissipates the energy by desorption, carrying along the analyte into the gaseous phase. During this desorption process, ions are formed by charge transfer between the thermal photo-excited matrix and analyte.

One problem with the MALDI method is the requirement of having to conduct the irradiation and ionization under vacuum. More recent developments have designed systems that may now work at atmospheric pressure (AP-MALDI). However, these systems and the MALDI systems suffer from the limitation that they produce a number of neutral molecules during the ionization. The desorbed neutral analyte to ion ratio can be in the range of about 1000:1. Also, a high percentage of these neutrals can be in excited states.

Field ionization sources are comprised of an emitter (anode) and a cathode. A high voltage of about 10 Killivolts (KV) is applied between the two electrodes to create a 10⁷-10⁸ V/em electric field nearby the emitter. The required electric field strength for field ionization may be reduced by as much as three orders of magnitude when the analyte is ionized in its excited state instead of its ground state as in the case of traditional field ionization. A problem with this type of technique concerns the amount of voltage needed to induce ionization as well as the problem of not being able to effectively ionize large sample sizes.

There is, therefore, a need to provide a system, ionization source and device that is capable of efficiently and effectively ionizing samples without the production of large amounts of neutrals.

These and other problems have been obviated and addressed by the present invention.

### SUMMARY OF THE INVENTION

The invention provides a mass spectrometr system, comprising an ion source for ionizing a sample comprising a surface for holding and ionizing a sample; a collection device adjacent to the surface for receiving ions that are ionized from the surface; a voltage source in electrical connection with the surface and the collection device for defining a field and field ionization source between the surface and the capillary; and a light source adjacent to the surface for producing a light for irradiating and ionizing the sample on the surface, wherein the voltage source produces a field ionization field for ionizing the sample and the light source produces a light for irradiating and ionizing the sample, and the sample on the surface is ionized.; and a detector downstream from the ion source for detecting the ions.

The invention also provides an ion source for ionizing a sample. The ion source comprises a surface for holding and ionizing a sample; a collection device adjacent to the surface for receiving ions that are ionized from the surface; a voltage source in electrical connection with the surface and the collection device for defining a field ionization source between the surface and the collection device; and a light source adjacent to the surface for producing a light for irradiating and ionizing the sample on the surface; wherein the voltage source produces a field ionization field for ionizing the sample and the laser produces a light for irradiating and ionizing the sample and the sample on the surface is ionized.

The invention also provides a method for ionizing a sample. The method comprises applying a field ionization field to the sample; and irradiating the sample with a light source to ionize the sample.

### BRIEF DESCRIPTION OF THE FIGURES

The invention is described in detail below with reference to the following figures:

FIG. 1 shows a general block diagram of the present invention.

FIG. 2 shows a perspective view of a first embodiment of the present invention.

FIG. 3 shows a second embodiment of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a housing” may include more than one “housing”. Reference to “an ion source” may include more than one “ion source”.

In describing and claiming the present invention, the following terminology will be used in accordance with the definitions set out below.

The term “adjacent” means near, next to, or adjoining.

The term “collection device” refers to a capillary, conduit, tube, pipe or similar type structure that may be used to collect ions. The structure may comprise any number of shapes and sizes and diameters. Other shapes, sizes and designs may also be possible.

The term “field ionization” and “field ionization source” refer to devices that use a voltage source and field to induce ionization. The term used herein shall have a definition as commonly used in the art.

The term “ion source” refers to devices that produce ions for further analysis and processing.

The term “light source” refers to any device, machine or apparatus capable of providing light to ionize a sample. For instance, a laser is an example of one type of light source. Light sources may comprise devices that may create light at various different wavelengths. Wavelengths may be in the ultraviolet, infrared, or visible light regions.

The term “surface” shall refer to any area in which a sample may be mounted. A surface may be planar or non-planar. A surface may comprise a portion of a sample plate. The term has broad based meaning to comprise any area capable of holding a sample.

The term “pointed surface” refers to a device, apparatus or surface having limited surface area. A pointed surface may be employed for mounting or positioning a sample. Pointed surfaces can range in size and have a radius of about 0.01 to 0.5 millimeters. Other sizes, widths and diameters are possible and the listed ranges should not be interpreted to limit the broad scope of the invention.

The term “voltage source” refers to any device, apparatus and/or machine that is capable of supplying a voltage. The term refers to any other electrical components and wiring that may be employed or required for operating such a device. The term has applicability to voltage sources used for field ionization. However, the invention should not be interpreted to be limited to these devices and voltages.

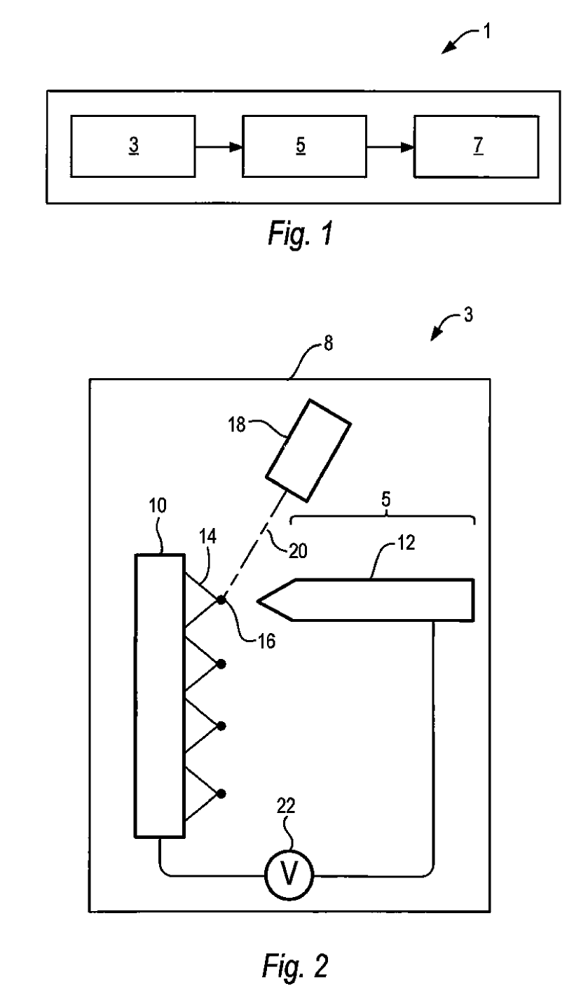

FIG. 1 shows a general block diagram of the present invention. The mass spectrometry system 1 of the present invention comprises an ion source 3, an ion collection device 5, and a detector 7. The ion collection device 5 is disposed adjacent to the ion source 3. In certain embodiments of the invention the ion collection device 5 may be integrated with the ion source 3. In other embodiments, the ion collection device 5 may also be disposed in the ion source 3. This is not a requirement of the invention and should not be interpreted to limit the broad scope of the invention.

The ion source 3 of the present invention may comprise complete devices, parts or components of ionization devices known in the art for producing ions. The ionization device must be capable of irradiating and ionizing an analyte. Typical ionization devices may comprise MALDI or AP-MALDI devices, similar type devices or their components. Other ionization devices and/or components such as a field ionization devices or similar type devices may also be employed. The ion source 3 may be maintained at atmospheric pressure. It may be also be maintained above or below atmospheric pressure. Atmospheric pressure is 760 Torr. Typical ranges above and below atmospheric pressure are about 100 Torr. However, this is not a requirement of the invention. Other ranges are also possible.

The ion collection device 5 may comprise any number of devices known in the art for collecting ions. For instance, the ion collection device 5 may comprise a conduit, pipe, a capillary or any other similar type device that is capable of collecting or capturing ions. In FIGS. 1-3 the ion collection device 5 is shown as a capillary 12.

The detector 7 is disposed downstream from the ion collection device 5. Any number of detectors may be employed with the present invention. For instance, the detector may comprise a QTOF, time-of-flight (TOF) or ion trap type device. Other detectors known in the art may also be employed. The detector 7 may be coupled with a photo-multiplier tube or similar type devices.

FIG. 2 shows a first embodiment of the present invention. The ion source 3 comprises a surface 10 for holding and ionizing a sample 16, a light source 18 and a voltage source 22. The ion collection device 5 (shown as capillary 12) is disposed adjacent to the ion source 3. As discussed the ion collection device 5 may comprise a conduit tube, or capillary.

The surface 10 may comprise any number of surfaces, materials or substrates known in the art for mounting, holding or ionizing a sample 16. In addition, the surface 10 may comprise any number of shapes, surface plates, and sizes. For instance, the surface 10 may comprise a pointed surface 14 or a surface having minimal sample mounting area. This makes it easier to ionize off of the surface 10. It should be noted that an optional housing 8 may be employed with the present invention.

The voltage source 22 is in electrical connection with the surface 10 and the ion collection device 5 for defining a field ionization field between the surface 10 and the collection device 5. The device is designed for ionizing a sample 16. An anode and cathode is defined between the surface 10 and the collection device 5. In this case the voltage source may create a voltage differential between the collection device 5 which may be at ground potential and the surface 10 which is at potential. A high voltage of about 10 KV is typically applied between the two electrodes (i.e. surface and ion collection device) to create a 10⁷-10⁸ V/cm electric field.

The light source 18 is disposed adjacent to the surface 10 for producing a light for irradiating and ionizing the sample 16 on the surface 10. A light 20 is generally irradiated upon the sample 16 and surface 10. This causes the sample 16 to become ionized. The light source 18 may comprise any number of light sources capable of ionizing a sample 16. For instance, the light source 18 may comprise a laser, ultraviolet (UV) light, infrared (IR) light, visible light or any other apparatus or device for producing a wavelength of light capable of ionizing a sample 16. The light source 18 is functionally employed to ionize a sample 16 off of the surface 10. For instance, if the light source 18 comprises a laser, the laser may be employed to irradiate the sample 16. The laser irradiates the sample 16 to create an ion plume. The light source 18 may be positioned at any number of locations adjacent to the surface 10. The light source 18 may be directed in any number of directions for irradiating the sample 16.

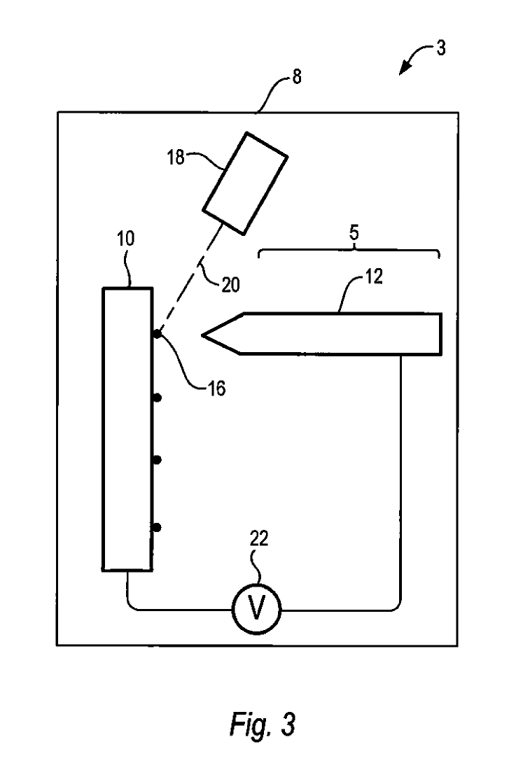

FIG. 3 shows a second embodiment of the present invention. In this embodiment of the invention, the surface 10 has been modified. The surface is planar in design.

Having described the system and apparatus of the invention, a description of the method of the invention is now in order.

The method of the invention may be employed for ionizing a sample 16 on the surface 10. The method for ionizing the sample 16 on the surface 10 comprises applying a field ionization field to the sample 16; and irradiating the sample 16 with a light source 22 to ionize the sample 16. This method has the advantage of having a voltage source 22 for creating a field for ease of ionizing the sample 16 on the surface 10. In addition, the light source 18 may simultaneously be employed to ionize the sample 16 while the sample 16 is in an excited Rydberg state. In this way both field ionization and laser desorption ionization processes can be initialized together. This combination will be able to increase detection sensitivity by post field ionizing the desorbed neutral analyte. This method and technique also provide the ability to lower the laser power required to carry out MALDI and other similar type ionization processes that are described above and may be used in combination with the field ionization method.

We claim:

1. An ion source for ionizing a sample, comprising:
(a) a surface for holding and ionizing a sample;
(b) an ion collection device adjacent to the surface for receiving ions that are ionized from the surface;
(c) a voltage source in electrical connection with the surface and the ion collection device for defining a field ionization field between the surface and the ion collection device; and
(d) a light source adjacent to the surface for producing a light for irradiating and ionizing the sample on the surface;
wherein the voltage source produces a field ionization field for ionizing the sample and the laser produces a light source for irradiating and ionizing the sample and the sample on the surface is ionized.

2. An ion source as recited in claim 1, wherein the surface comprises a portion of a sample plate.

3. An ion source as recited in claim 1, wherein the surface comprises a pointed surface.

4. An ion source as recited in claim 2, wherein the pointed surface comprises a radius of about 0.01 to 0.5 millimeters.

5. An ion source as recited in claim 1, wherein the ion source is under vacuum.

6. An ion sources as recited in claim 1, wherein the ion source is at atmospheric pressure.

7. An ion source as recited in claim 1, wherein the ion source is below atmospheric pressure.

8. An ion source as recited in claim 1, wherein the voltage source applies a voltage between the surface and the capillary of about 5 to 20 KV.

9. An ion source as recited in claim 1, wherein the light source comprises a laser.

10. An ion source as recited in claim 1, wherein the light source comprise an ultraviolet light (UV) source.

11. An ion source as recited in claim 1, wherein the light source comprises an infrared light (IR) light source.

12. A mass spectromety system, comprising:
(a) an ion source for ionizing a sample comprising:
(i) a surface for holding and ionizing a sample;
(ii) an ion collection device adjacent to the surface for receiving ions that are ionized from the surface;
(iii) a voltage source in electrical connection with the surface and the collection device for defining a field ionization field between the surface and the collection device; and
(IV) a light source adjacent to the surface for producing a light source for irradiating and ionizing the sample on the surface;
wherein the voltage source produces a field ionization field for ionizing the sample and the light source produces a light for irradiating and ionizing the sample and the same sample on the surface is ionized.; and
(b) a detector downstream from the ion source for detecting the ions.

13. A mass spectrometry system as recited in claim 12, wherein the surface comprises a portion of a sample plate.

14. A mass spectrometry system as recited in claim 12, wherein the surface comprises a pointed surface.

15. A mass spectrometry system as recited in claim 14, wherein the pointed surface comprises a radius of about 0.01 to 0.5 millimeters.

16. A mass spectrometry system as recited in claim 12, wherein the ion source is under vacuum.

17. A mass spectrometry system as recited in claim 12, wherein the ion source is at atmospheric pressure.

18. A mass spectrometry system as recited in claim 12, wherein the ion source is below atmospheric pressure.

19. A mass spectrometry system as recited in claim 12, wherein the voltage source applies a voltage between the surface and the capillary of about 5 to 20 KV.

20. A mass spectrometry system as recited in claim 12, wherein the light source comprises a laser.

21. A mass spectrometry system as recited in claim 12, wherein the light source comprise an ultraviolet light (UV) source.

22. A mass spectrometry system as recited in claim 12, wherein the light source comprises an infrared light (IR) light source.

23. A mass spectrometry system as recited in claim 12, wherein the detector comprises a time of flight detector.

24. A mass spectrometry system as recited in claim 12, wherein the detector comprises a Q-TOF detector.

25. A method for ionizing a sample on a surface, comprising:
(a) applying a field ionization field to the sample; and
(b) irradiating the sample with a light source to ionize the sample.

26. A method of ionizing a sample as recited in claim 25, wherein the light source comprises a laser.
